(19) United States
(12) Patent Application Publication
(10) Pub. No.: US 2022/0233397 A1
(43) Pub. Date: Jul. 28, 2022

(54) FASCIAL GUN HAVING FUNCTION OF INTELLIGENTLY ADJUSTING STRIKING

(71) Applicant: SHENZHEN FITTOP HEALTH TECHNOLOGY CO., LTD., Shenzhen (CN)

(72) Inventor: Wei Huang, Shenzhen (CN)

(21) Appl. No.: 17/697,394

(22) Filed: Mar. 17, 2022

Related U.S. Application Data
(63) Continuation of application No. PCT/CN2019/124649, filed on Dec. 11, 2019.

(30) Foreign Application Priority Data
Sep. 17, 2019 (CN) 201921546841.7
Sep. 17, 2019 (CN) 201921546950.9
Sep. 17, 2019 (CN) 201921557362.5
Sep. 17, 2019 (CN) 201921560620.5
Sep. 17, 2019 (CN) 201921560851.6
Sep. 18, 2019 (CN) 201921559252.2

(51) Int. Cl. A61H 23/00; A61H 23/02

(52) U.S. Cl. CPC A61H 23/006; A61H 23/0263; A61H 2201/0153; A61H 2201/5025; A61H 2201/5084; A61H 2201/5069; A61H 2201/0188; A61H 2201/5064

(57) ABSTRACT

This present invention discloses a fascial gun having a function of intelligently adjusting striking, including a fascial gun body and an electric power device. The fascial gun body includes a fascial gun housing and a massage head, and the fascial gun housing is provided therein with a main circuit board with an MCU, a motor electrically connected to the main circuit board, and a reciprocating mechanism connected to an output shaft of the motor. The electric power device supplies electric power to the main circuit board, the reciprocating mechanism is provided with a sliding shaft which penetrates through the fascial gun housing and is connected to the massage head, the main circuit board is electrically connected to a detection device used for detecting the operating state of the fascial gun, and the MCU controls the rotation speed of the motor according to information sent by the detection device.

### CROSS-REFERENCE TO RELATED PATENT APPLICATION

This application is a continuation application of International Patent Application No. PCT/CN2019/124649, filed on Dec. 11, 2019, which itself claims priority to Chinese Patent Application No. CN201921546841.7 filed in China on Sep. 17, 2019, Chinese Patent Application No. CN201921546950.9 filed in China on Sep. 17, 2019, Chinese Patent Application No. CN201921560620.5 filed in China on Sep. 17, 2019, Chinese Patent Application No. CN201921560851.6 filed in China on Sep. 17, 2019, Chinese Patent Application No. CN201921557362.5 filed in China on Sep. 17, 2019, and Chinese Patent Application No. CN201921559252.2 filed in China on Sep. 18, 2019. The disclosures of the above applications are incorporated herein in their entireties by reference.

### TECHNICAL FIELD

The present invention relates to the technical field of medical and health care equipment, in particular to a fascial gun having function of intelligently adjusting striking.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Exercise and fitness have been popularized in current urban life. Muscle stiffness and soreness following an exercise will happen to the people who seldom take exercise, but to the people who often take exercise, such phenomenon still exists, heretofore muscle relaxation after taken exercise is an effective method to solve this problem. An fascial gun, as one kind of medical and health care equipment used by the people who relax muscles after taken exercise, can break off muscle adhesion, make muscles hot, activate cells, and more smooth blood flow under its precise, high-frequency, and deep vibration, thereby accelerating muscle recovery and reducing lactic acid. Following an exercise, people can clearly experience the effect brought about by the fascial gun after applied it on the local muscles for 15-25 seconds, so it can be used by both professional athletes and amateur bodybuilders. However, of any existing fascial gun, strength of striking is set by manual adjustment, being extremely inconvenient to use.

### SUMMARY

Due to the defect of the existing fascial gun incapable of automatically adjusting the strength of striking, the present invention provides a fascial gun having function of intelligently adjusting striking.

In the present invention, a fascial gun having function of intelligently adjusting striking conceived as a technical solution comprises a fascial gun body and an electric power device, wherein the fascial gun body includes a fascial gun housing and a massage head, the fascial gun housing is provided therein with a main circuit board with an MCU, a motor electrically connected to the main circuit board, and a reciprocating mechanism connected to an output shaft of the motor, the electric power device supplies electric power to the main circuit board, and the reciprocating mechanism is provided with a sliding shaft which penetrates through the fascial gun housing and which is connected to the massage head, the main circuit board is electrically connected with a detection device used for detecting the operating state of the fascial gun, and the MCU controls the rotation speed of the motor according to the information sent by the detection device.

In the first embodiment, the detection device includes a distance sensor which is arranged at the front end of the fascial gun housing and which adjoins the position out of which the sliding shaft penetrates through the fascial gun housing.

Preferably, the distance sensor is an infrared distance sensor or a laser distance sensor, either of which has a sensor window arranged on a dustproof opening.

Preferably, the distance sensor is positioned at the lower front end of the fascial gun housing.

In the second embodiment, the detection device includes a radio frequency recognizer which is arranged on the fascial gun housing and which can identify an electronic tag arranged on the massage head, and the massage head is detachably connected to the sliding shaft.

Preferably, the massage head includes a massage head cover and a cylindrical massage head post, the sliding shaft is a cylindrical shell which the massage head post fits inside, the massage head cover is fixedly installed on the head of the massage head post, the tail of the massage head post fits inside the sliding shaft, a positioning device is arranged between the portions where the massage head post is connected with the sliding shaft, the electronic tag is arranged inside the tail of the massage head post.

Preferably, the positioning device includes at least one positioning bead arranged on the massage head post, and a positioning hole which is arranged on the sliding shaft and which the positioning bead fits inside.

Preferably, the positioning bead includes a rigid spherical bead, an installation holder for installing the spherical bead, and a spring that abuts against the spherical bead and that partially exposes the spherical bead in the installation holder, an installation hole fitting with the installation holder is arranged on the massage head post.

Preferably, the massage head post is provided with at least one engaging groove along one circumferential circle of the massage head post between the portion provided with the positioning device and the tail of the massage head post, a buffer ring fits inside and engages with the engaging groove, the buffer ring partially protrudes outside the engaging groove.

In the third embodiment, the detection device includes a linear acceleration sensor.

Preferably, the detection device further includes an angular acceleration sensor.

Preferably, while the linear acceleration sensor includes three single-axis linear acceleration sensors, the angular acceleration sensor includes three single-axis angular acceleration sensors, and the three single-axis linear acceleration sensors and the three single-axis angular acceleration sensors form an inertial measurement unit.

The reciprocating mechanism of the fascial gun in the present invention includes: a motor electrically connected to the main circuit board and fixed on a motor holder, an eccentric wheel fixedly connected to the output shaft of the motor, a connecting rod, and a sliding axle capable of penetrating through the fascial gun housing and moving forwards and backwards. The motor holder is fixedly connected inside the fascial gun housing, rubber rings are arranged at the four corners of the motor holder toward the side walls of the fascial gun housing. There is a first bearing fixed with one end of the connecting rod that is connected via transmission means to the eccentric wheel interference-fitted in the inner ring of the first bearing, and there is a second bearing fixed with another end of the connecting rod that is connected via transmission means to the sliding axle fixed in the inner ring of the second bearing.

Preferably, both ends of the connecting rod are correspondingly provided with a first through hole and a second through hole, the lower ends of which both have annular protrusions extending radially inwards. The eccentric wheel extends upwards at the connection with the output shaft of the motor to form a connecting protrusion post interference-fitted in the inner ring of the first bearing, the first bearing fits inside the first through hole and abuts against the upper surface of the annular protrusion inside the first through hole. The second bearing fits inside the second through hole and abuts against the upper surface of the annular protrusion inside the second through hole, the sliding axle is fixedly connected to the inner ring of the second bearing by a sliding axle fixing block, the upper and lower surfaces of the sliding axle fixing block are correspondingly provided with a connecting post interference-fitted in the inner ring of the second bearing and fixedly connected to the sliding axle.

The fascial gun housing of the present invention includes an outer housing and an inner housing, the outer housing covers the inner housing, the inner housing includes an upper cover and a bottom housing engaging with each other, the reciprocating mechanism and the main circuit board are all arranged on the bottom housing, the upper cover and the bottom housing engage with each other to form a third through hole out of which the sliding axle penetrates, the sliding axle is detachably connected to the massage head, penetrating through the third through hole, a sleeve sleeving the sliding axle is fixed inside the inner housing.

Preferably, the main circuit board is also electrically connected with a stepless-adjustment switch used for steplessly adjusting the rotation speed of the motor, the stepless-adjustment switch is arranged on the fascial gun housing.

In the present invention, the electric power device of the fascial gun is an electric supply or a battery assembly, the battery assembly includes a battery housing provided with a containing cavity inside and connected to the fascial gun body at the top, a battery pack arranged in the containing cavity, and a power supply connection piece that is arranged on the top of the battery housing to electrically connect the fascial gun body with the battery pack. The battery pack is composed of a plurality of rechargeable batteries, the top of the battery housing is provided with a first ventilation hole passing through the top of the battery housing, the bottom of the battery housing is provided with a second ventilation hole passing through the bottom of the battery housing.

Preferably, the battery pack is formed by parallel-connecting a plurality of rechargeable batteries or first series-connecting and then parallel-connecting them, the power supply connection piece includes a positive power supply connection piece, a negative power supply connection piece, and an information transmission connection piece used to transmit information for the battery pack, and the positive power supply connection piece, the negative power supply connection piece, and the information transmission connection piece are all electrically connected and conduct electricity to the fascial gun body after the battery assembly has been connected to the fascial gun body.

Preferably, the battery pack is electrically connected with a power supply circuit board arranged at the bottom end of the battery pack, the power supply circuit board is provided with a first LED lamp positioned downwards, the battery housing includes a left housing and a right housing engaging with each other to form the containing cavity, an annular battery cover and a battery tail cover, the lower end of the containing cavity has an opening, the power supply circuit board is positioned at the lower part of the containing cavity, the lower ends of the left housing and the right housing engaging with each other engage with the upper part inside the ring of the battery cover, the battery tail cover fits inside the lower part inside the ring of the battery cover, a ring-shaped first light-transmitting aperture capable of transmitting the first LED light is arranged between the battery tail cover and the battery cover, the first ventilation hole is arranged on the battery tail cover and allows a passage for the air flow of the containing cavity, the power supply connection piece and the second ventilation hole are arranged on the top surface of the left housing or/and the right housing.

Preferably, an extension portion extends radially inwards along the edge of the top of the first light-transmitting aperture, a protrusion protrudes radially inside the ring of the battery cover, and a part of the top of the first light-transmitting aperture abuts against the lower surface of the protrusion, the lower ends of the left housing and the right housing abut against the upper surface of the protrusion.

Preferably, the power supply circuit board is provided with a power button on which a silicone button cap is arranged, the silicone button cap is connected to a button holder in which a button shaft capable of sliding in the button holder and positioned between the silicone button cap and the power button is arranged, the button shaft abuts against the power button.

Preferably, the power supply circuit board is electrically connected with a first charging interface used to charge the battery pack, the first charging interface is embedded on the battery tail cover, the battery assembly fits with a charging base, the charging base includes a charging base outer housing provided with a groove, and a annular charging base inner housing fitting with the battery housing to be inserted, the charging base inner housing is arranged on the bottom surface of the groove and forms an annular groove with the charging base outer housing, the bottom surface of the groove is provided with a second charging interface positioned in the charging base inner housing and fitting and connected with the first charging interface, a charging base circuit board electrically connected with the second charging interface and having a second LED lamp is arranged in the annular groove, the top matching cover of the annular groove is provided with an annular light-scattering aperture sleeved with an annular second light-transmitting aperture, a charging connector electrically connected to the charging base circuit board is arranged on the charging base outer housing.

Preferably, a balance weight is arranged on the bottom of the charging base circuit board inside the annular groove, and one of or both an anti-skid mat and a sucker is arranged on the bottom of the charging base outer housing.

Preferably, the center of the top of the battery housing extends axially upwards to form a power supply protruding post, the first ventilation hole is a hole axially passing through the power supply protruding post, a plurality of connection holes used for connecting with the fascial gun body are alternately arranged circumferentially on the edge of the top of the power supply protruding post, a plurality of fixation connection posts used for connecting with the fascial gun body are alternately arranged circumferentially on the edge of the top of the battery housing, a power supply hole for the connection and electric conduction between the power supply connection piece and the battery pack is arranged on the side wall of the power supply protruding post.

Preferably, the battery housing is covered by a silicone cover.

Preferably, a battery monitoring module used to monitor the battery pack is arranged on the main circuit board, a third ventilation hole capable of allowing a passage for the airflow of the second ventilation hole is arranged on the fascial gun housing.

In the present invention, an audio module is provided on the main circuit board of the fascial gun, the audio module includes an audio chip arranged on the main circuit board, and a loudspeaker electrically connected with the main circuit board and arranged inside the fascial gun housing, a sound outlet opening used for transmitting the sound from the loudspeaker is arranged on the fascial gun housing.

Preferably, an indicator lamp electrically connected to the main circuit board is arranged inside the fascial gun housing, a light-transmitting window through which the indicator light is emitted is arranged on the fascial gun housing.

Preferably, a light-guiding ring capable of reflecting light toward the indicator lamp, and a light-scattering aperture capable of scattering light and arranged between the light-guiding ring and the indicator lamp are further arranged inside fascial gun housing, the light-transmitting window is arranged on the fascial gun housing toward the position of the light-guiding ring.

Preferably, a display screen electrically connected to the main circuit board is arranged on the fascial gun housing.

Compared with the prior art, by detecting the operating state of the fascial gun by means of the detection device designed out in the present invention, and sending the sensed information to the MCU that analyzes the received information to control the operation of the motor and adjust the strength of massage and striking, people can achieve automatically controlling and adjusting the strength of striking, avoid damage to human bones and enjoy the convenience of use.

### BRIEF DESCRIPTION OF THE DRAWINGS

We will describe the present invention in detail in combination with the embodiments and drawings as follows:

FIG. 1 is a breakdown structural diagram of the first embodiment according to the present invention;

FIG. 2 is a structural diagram of the distance sensor of the first embodiment according to the present invention;

FIG. 3 is a cross-sectional view of the first embodiment according to the present invention;

FIG. 4 is a schematic diagram of the external structure of the first embodiment according to the present invention;

FIG. 5 is a cross-sectional view of the second embodiment according to the present invention;

FIG. 6 is an enlarged structural diagram of A in FIG. 5 of the second embodiment according to the present invention;

FIG. 7 is a structural diagram of the massage head in the second embodiment according the present invention;

FIG. 8 is a breakdown structural diagram of the massage head in the second embodiment according the present invention;

FIG. 9 is a schematic diagram of the external structure of the second embodiment according to the present invention;

FIG. 10 is a breakdown structural diagram of the third embodiment according to the present invention;

FIG. 11 is a schematic diagram of each module on the circuit board of the third embodiment according to the present invention;

FIG. 12 is a cross-sectional view of the third embodiment according to the present invention;

FIG. 13 is an outside view of the third embodiment according to the present invention;

FIG. 14 is a schematic diagram of the internal structure of the fascial gun according to the present invention;

FIG. 15 is a breakdown structural diagram of the fascial gun according to the present invention;

FIG. 16 is a cross-sectional view of the fascial gun according to the present invention;

FIG. 17 is an outside view of the fascial gun according to the present invention;

FIG. 18 is a schematic diagram of the module structure on the main circuit board according to the present invention;

FIG. 19 is a breakdown structural diagram of the battery assembly according to the present invention;

FIG. 20 is a schematic diagram of the top structure of the battery assembly according to the present invention;

FIG. 21 is a schematic diagram of the bottom structure of the battery assembly according to the present invention;

FIG. 22 is a cross-sectional view of the battery assembly connected to the fascial gun body according to the present invention;

FIG. 23 is an enlarged structural diagram of A in FIG. 22 in the present invention;

FIG. 24 is a structural diagram of the battery assembly connected to the fascial gun body according to the present invention;

FIG. 25 is a structural diagram of the charging base according to the present invention;

FIG. 26 is a breakdown structural diagram of the charging base according to the present invention.

Wherein, 1—fascial gun body; 10—fascial gun housing; 101—outer housing; 102—upper cover; 103—bottom housing; 11—main circuit board; 12—massage head; 121—massage head cover; 122—massage head post; 123—positioning device; 210—installation hole; 211—engaging groove; 212—buffer ring; 220—positioning bead; 221—positioning hole; 2200—spherical bead; 2201—installation holder; 2202—spring; 13—third ventilation hole; 14—reciprocating mechanism; 2—electric power device; 20—battery housing; 21—battery pack; 22—power supply connection piece; 200—containing cavity; 201—first ventilation hole; 202—second ventilation hole; 203—left housing; 204—right housing; 205—battery cover; 206—battery tail cover; 207—power supply protruding post; 208—fixation connection post; 2050—protrusion; 2070—connection hole; 2071—power supply hole; 209—indicator lamp; 23—distance sensor; 24—stepless-adjustment switch; 25—light-transmitting window; 26—light-guiding ring; 27—light-scattering aperture; 230—probe; 231—sensor circuit board; 232—sensor window; 28—radio frequency recognizer; 29—electronic tag; 3—power supply circuit board; 30—linear acceleration sensor; 31—angular acceleration sensor; 32—battery monitoring module; 33—audio module; 34—loudspeaker; 300—audio chip; 15—first LED lamp; 150—light-transmitting aperture; 151—extension portion; 4—motor; 40—output shaft; 401—motor holder; 402—rubber ring; 5—eccentric wheel; 500—connecting protrusion post; 50—connecting rod; 51—sliding axle; 52—first bearing; 53—second bearing; 54—first through hole; 55—second through hole; 56—annular protrusion; 57—connecting post; 530—sliding axle fixing block; 16—power button; 160—silicone button cap; 161—button holder; 162—button shaft; 17—sound outlet opening; 6—first charging interface; 7—charging base; 70—charging base outer housing; 71—charging base inner housing; 72—second charging interface; 73—charging base circuit board; 701—groove; 702—charging connector; 703—anti-skid mat; 704—sucker; 740—second LED lamp; 7010—annular light-scattering aperture; 7011—second light-transmitting aperture; 7012—balance weight; 8—silicone cover; 9—display screen.

### DETAILED DESCRIPTION

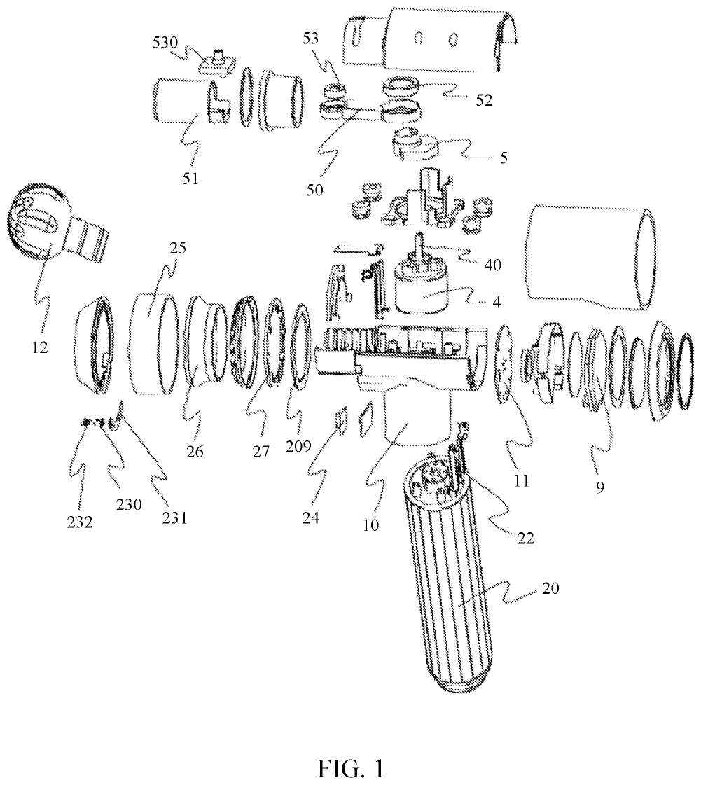

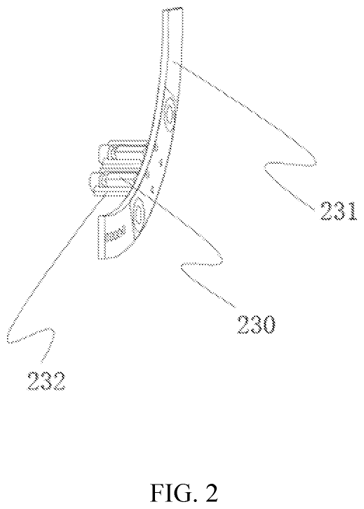

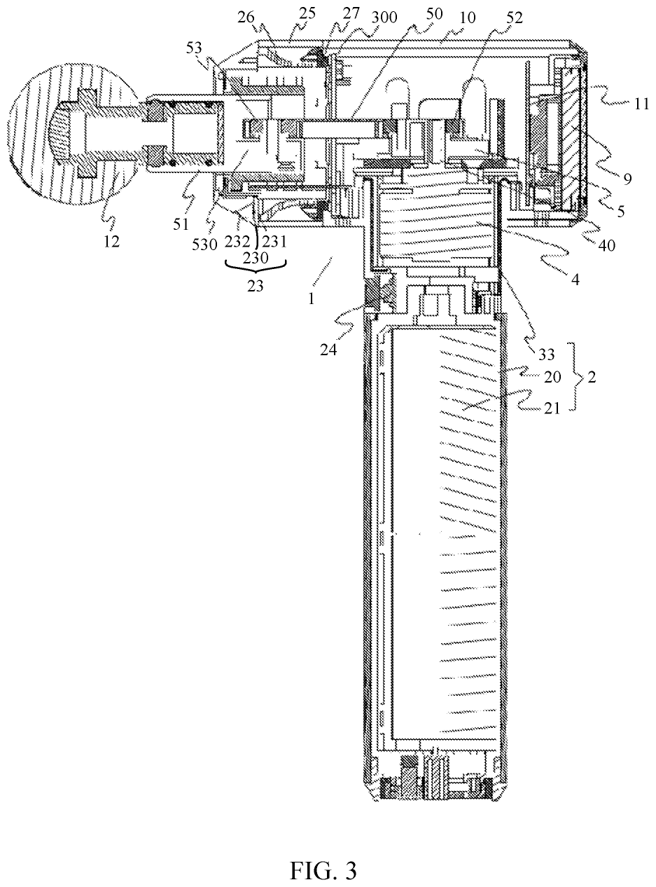

As shown in FIGS. 1-3, the fascial gun provided by the present invention includes the fascial gun body 1 and the electric power device 2.

The fascial gun body 1 includes a fascial gun housing 100 and a massage head 12, the fascial gun housing 100 is provided therein with the main circuit board 11 with an MCU, the motor 4 electrically connected to the main circuit board 11, and the reciprocating mechanism connected to an output shaft 40 of the motor, the electric power device 2 supplies electric power to the main circuit board 11, and the reciprocating mechanism is provided with the sliding shaft 51 which penetrates through the fascial gun housing 100 and which is connected to the massage head 12. The housing may be configured to be a similar T-shaped state for easy holding and use, and on each occasion, to be composed of a single housing with a cavity inside, or two or more housing connected to form a containing cavity. The main circuit board 11 acts as the control center of the fascial gun to control the operation of the reciprocating mechanism. The main circuit board 11 is electrically connected with the detection device used for detecting the operating state of the fascial gun, and the MCU controls the rotation speed of the motor 4 according to the information sent by the detection device.

In the first embodiment, as shown in FIGS. 1-3, the detection device includes a distance sensor which is arranged at the front end of the fascial gun housing and which adjoins the position out of which the sliding shaft penetrates through the fascial gun housing. That is, corresponding to the end where the massage head 12 is installed, the solution provides the distance sensor 23 by which the distance between the massage head 12 and a human body is sensed, so as to perform accurate massage. Preferably, the distance sensor 23 is positioned at the lower front end of the fascial gun housing, so that when people hold the fascial gun for striking and massage, positioning the distance sensor 23 in the area surrounded by the fascial gun, the arm and the body, the distance sensor 23 can always face the human body. In order to avoid the massage head 12 from influencing on the interaction with the distance sensor 23, the distance sensor 23 is configured to adjoin the position out of which the sliding shaft 51 penetrates through the fascial gun housing 10, and which can be any position that encircles the fascial gun housing 10 around the position out of which the sliding shaft 51 penetrates, and that is not blocked by massage head 12, up and down, left and right; the distance sensor 23 may also be configured to be positioned on the arc or inclined surface which is arranged at the front end of the fascial gun housing 10, so that the distance sensor 23 can sense the distance between the massage head 12 and the body, thus transmit the sensed information to the MCU, which controls the operation of the motor 4 according to the received information. When the distance is too far, the MCU will put the motor 4 into a standby state instead of running, avoiding accidental hits due to turning on the motor and its immediate running, and ensuring that the correct massage head 12 is applied to the correct body part, meanwhile the distance sensor 23 senses such a distance as to effect striking and massage, then the MCU will automatically adjust the rotation speed of the motor 4 according to the sensed distance, so as to adjust the most suitable striking force, and avoid injuries due to striking strongly at very close distance, or failure to massage and soothe muscles due to striking weakly at very long distance. The distance sensor 23 includes the probe 230 and the sensor circuit board 231 positioned inside the fascial gun housing 10. The sensor circuit board 231 is electrically connected to the main circuit board 11 through wires, and an opening for the probe 230 to detect is arranged on the fascial gun housing 10. The probe 230 is installed in the opening or at the position corresponding to and in contact with the opening inside the fascial gun housing 10. Thus, the above configuration facilitates the arrangement of various elements inside the fascial gun housing 10 and simplifies the layout of the main circuit board 11. The distance sensor 23 is an infrared distance sensor or a laser distance sensor, and the sensor window 232 is arranged on the dustproof opening. Both the infrared distance sensor and the laser distance sensor are commonly used, so it can save costs. Configuring the sensor window 232 on the dustproof opening avoids dust or other debris from influencing on the probe, or entering into the fascial gun housing 10 to affect the use of the fascial gun.

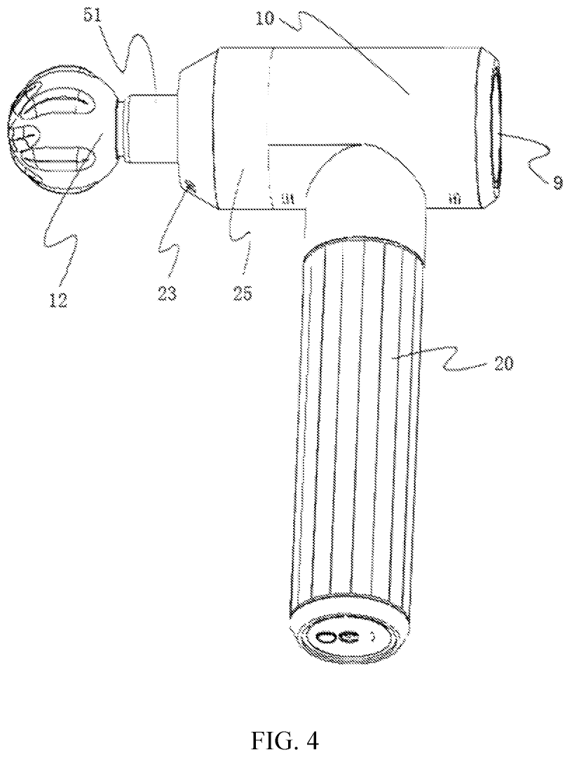

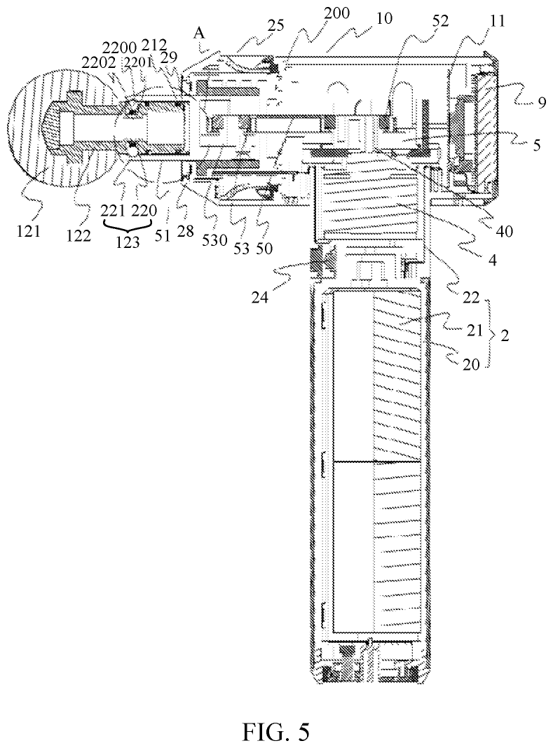

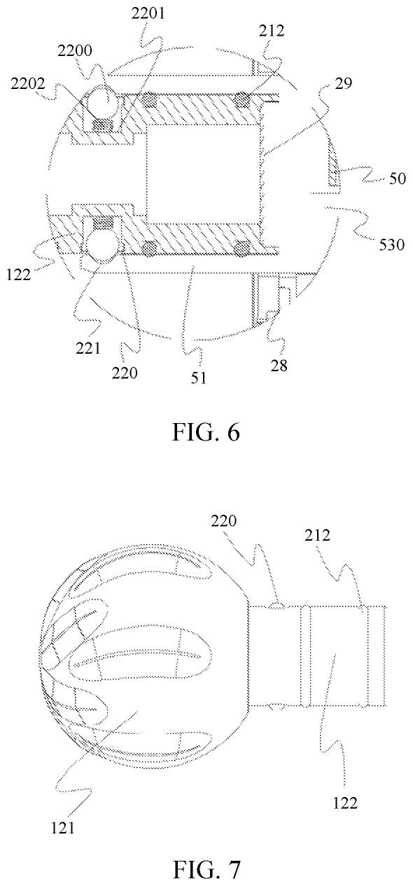

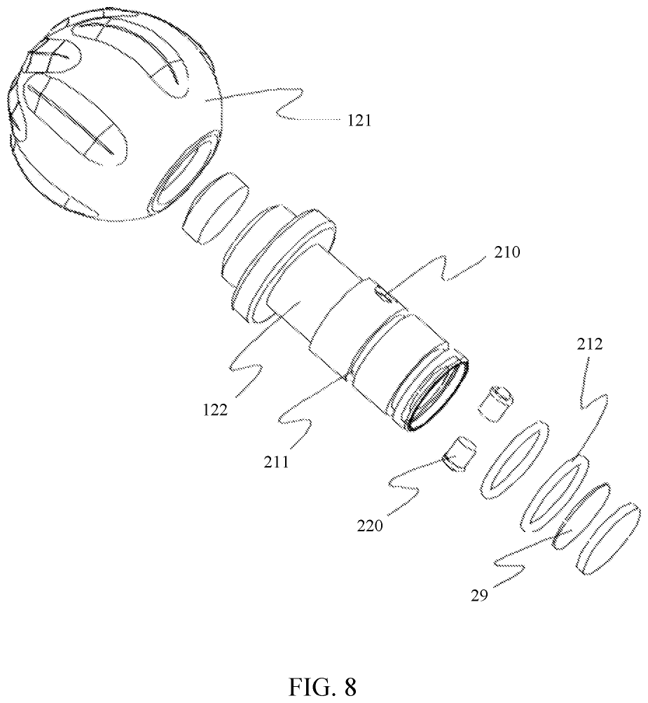

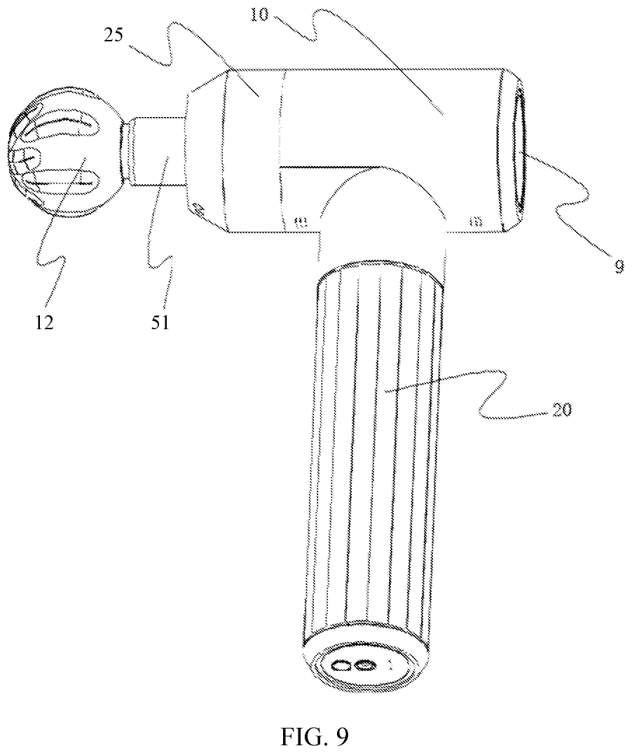

In the second embodiment, as shown in FIGS. 4-9, the detection device includes the radio frequency recognizer, and the sliding shaft 51 penetrates out of the fascial gun housing 10 and is detachably connected to the massage head 12. This means that corresponding to the sliding shaft 51 on the fascial gun housing 10 there is a through hole arranged out of which the sliding shaft 51 penetrates. The sliding shaft 51 is driven by the motor 4 to stretch out and draw back in the through hole, and the massage head 12 is installed on the sliding shaft 51. In the case that the sliding shaft 51 moves telescopically, it drives the massage head 12 to perform striking and massage, in addition, the detachable connection makes it possible to select a suitable massage head 12 according to the position to be massaged. The main circuit board 11 is electrically connected with the radio frequency recognizer 28 arranged on the fascial gun housing 10, the radio frequency recognizer 28 can be arranged outside the fascial gun housing 10 and electrically connected to the main circuit board 11, it may also be arranged inside the fascial gun housing 10 and electrically connected to the main circuit board 11. If the radio frequency recognizer 28 is arranged outside the housing, it will affect the appearance of the product and also risk use with damage. Therefore, the radio frequency recognizer 28 is preferably installed inside the fascial gun housing 10, thus it can be separately arranged on a circuit board and then connected to the main circuit board 11 through wires. The electronic tag 29 that can be identified by the radio frequency recognizer 28 is arranged on the massage head 12, furthermore in order to prevent the reading of the electronic tag 29 from being affected, it is preferably arranged at the front end of the fascial gun housing 10. After the massage head 12 has been installed on the fascial gun housing 10, the distance between the massage head 12 and the electronic tag 29 becomes closer, and the interaction between both also becomes more sensitive. The electronic tag 29 is preferably a passive RFID tag, and the corresponding radio frequency recognizer 28 is a RFID reader. The passive RFID tag is simple, inexpensive and easy to use, and is not limited by external conditions, nor easily damaged during the installation of the massage head 12. The main circuit board 11 is also electrically connected with the electric power device 2 that supplies electric power to the main circuit board 11. The electronic tags 29 differ from each other according to various shapes of the massage heads 12 where they are arranged, after various electronic tags 29 have been installed on the fascial gun housing 10, the radio frequency recognizer 28 on the fascial gun housing 10 will read the information in the electronic tags 29, and then transmit the information to the MCU which will identify various massage heads 12 according to the received information, thereby adjusting the rotation of the motor 4 to adapt to the massage of various massage heads 12. As for the massage head 12, in order to facilitate the installation and connection to the sliding shaft 51 and the striking of the massage head 12, the massage head 12 includes the massage head cover 121 and the cylindrical massage head post 122. The massage head cover 121 is configured to have different shapes according to different body parts to be massaged and is installed on the massage head post 122, and its material may be ordinary silica gel, foamed silica gel, rubber, or the like; meanwhile, the massage head post 122 is used to install the massage head cover 121 on the one hand, and connect with the sliding shaft 51 on the other hand, furthermore its cylindrical body facilitates the smoothness of the massage head 12 with the telescopic movement of the sliding shaft 51. The sliding shaft 51 is a cylindrical shell which the massage head post 122 fits inside. This means that the outer diameter of the massage head post 122 matches the inner diameter of the sliding shaft 51, the massage head cover 121 is fixedly installed on the head of the massage head post 122, and the tail of the massage head post 122 fits inside the sliding shaft 51, in this way, the tail of the massage head post 122 is wrapped by the sliding shaft 51, so that no external components bump against the fascial gun housing 10 during the telescopic movement of the sliding shaft 51 to hinder the telescopic movement of the sliding shaft 51. Furthermore, the positioning device 123 is arranged between the portions where the massage head post 122 is connected with the sliding shaft 51, and the massage head post 122 is connected and fixed to the sliding shaft 51 through the positioning device 123, so that the massage head 12 can be driven by the motor 4 to perform smooth striking and massage without falling off the sliding shaft 51. The positioning device 123 may be a structure that the two parts engage with each other, or a positioning structure generated by elastic deformation. The electronic tag 29 is arranged inside the tail of the massage head post 122, and a groove may be arranged at the tail of the massage head post 122, thus the electronic tag 29 is arranged in the groove to avoid damage to the electronic tag 29 during installation of the massage head 12, so it facilitates the identification of the radio frequency recognizer 28. As for the positioning device 123, the positioning device 123 includes at least one positioning bead 220 arranged on the massage head post 122, and a positioning hole which is arranged on the sliding shaft 51 and which the positioning bead 220 fits inside. After the massage head post 122 has been connected and installed on the sliding shaft 51, the positioning bead 220 fits inside and engages with the positioning hole 221 to fix the massage head 12, furthermore, in order to facilitate installation and use, as well as replace the positioning bead 220, the positioning bead 220 includes a rigid spherical bead 2200, an installation holder 2201 used for installing the spherical bead 2200, and a spring 2202 that abuts against the spherical bead 220 and that partially exposes the spherical bead 2200 in the installation holder 2201, an installation hole 210 fitting with the installation holder 2201 is arranged on the massage head post 122. The rigidity of the spherical bead 2200 enables its non-deformation during use, ensuring firm and reliable installation and positioning. The sizes of the installation hole 210 and the installation holder 2201 match with each other, and the installation holder 2201 will not protrude from the surface of the massage head post 122 after it has been installed in the installation hole 210, so it will not affect the installation of the massage head 12. During installation, the spherical bead 2200 is retracted into the installation holder 2201 under the pressure of the side wall of the sliding shaft 51, and the massage head post 122 is inserted into the sliding shaft 51. When the positions of the spherical bead 2200 and the positioning hole 221 correspond to each other, the spherical bead 2200 protrudes from the installation hole 210 under the elastic force of the spring 2202 and engages inside the positioning hole 221 to install and fix the massage head 12. In order to stabilize the connection between the massage head 12 and the sliding shaft 51, at least one engaging groove 211 is arranged along one circumferential circle of the massage head post 122 between the portion of the massage head post 122 where the positioning device is arranged and the tail of the massage head post 122. The buffer ring 212 fits inside and engages with the engaging groove 211, partially protruding from the engaging groove 211 and abutting against the side wall of the sliding shaft 51, thereby increasing the friction force between the massage head post 122 and the sliding shaft 51, and stabilizing the connection; meanwhile, the buffer ring 212 can also buffer the vibration of the product during use, thereby reducing the noise of the product. The buffer ring 212 can be made from silica gel or materials capable of elastic deformation.

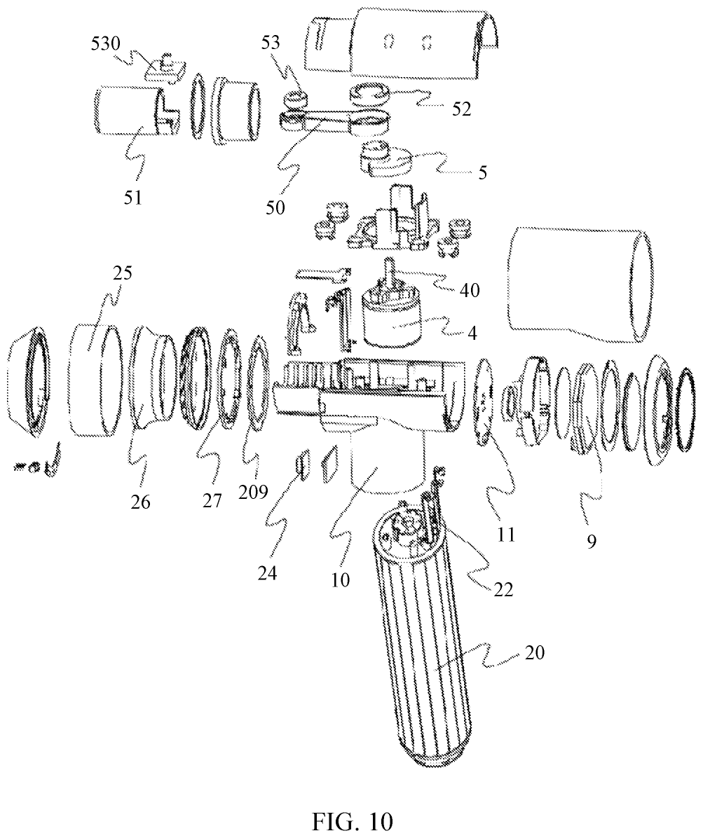

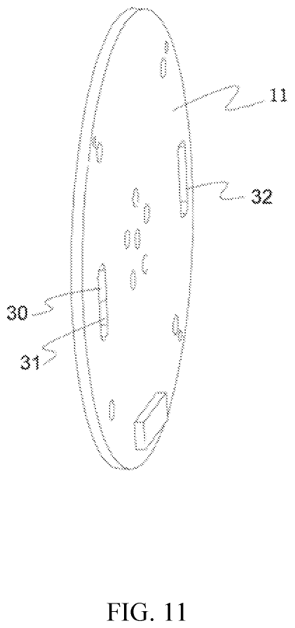

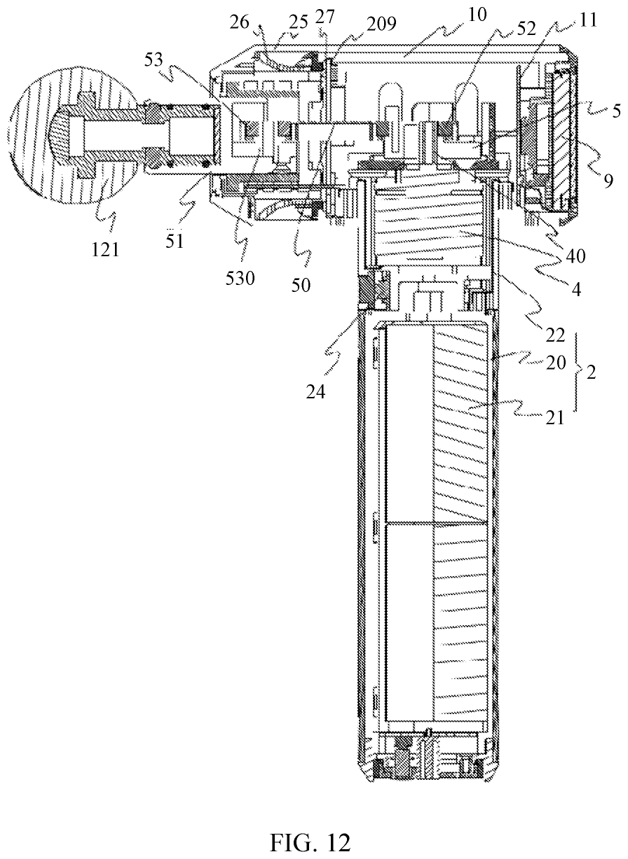

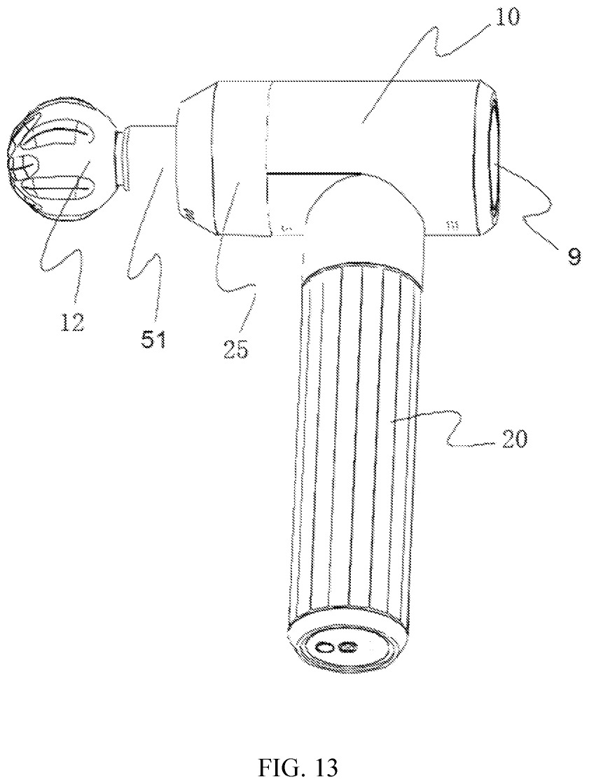

In the third embodiment, as shown in FIGS. 10-13, the detection device includes a linear acceleration sensor. The linear acceleration sensor 30 electrically connected to the MCU is arranged on the circuit board 3, due to interaction between forces, it can sense the strength of striking during the process of the massage and striking of the massage head 12. When striking hard objects such as joint bones, the linear acceleration sensor 30 senses a large force, meanwhile it transmits the corresponding information to the MCU which automatically adjusts the rotation speed of the motor 4 according to the received information, thus the motor 4 will operate at a decelerated speed. After operated at a decelerated speed for 3 seconds, if the hard object dissolves, the motor 4 will return to its original speed; if the hard object does not dissolve, it continues to operate at a decelerated speed. By means of the sensing of the linear acceleration sensor 30 and the control of the MCU, the fascial gun can well adapt to the body part of striking and massage and adjust itself to the corresponding strength, avoiding the damage to the skeletal joints when striking them, so it is easy to use. Due to the different manners that people hold the fascial gun in use, the force direction of the massage head 12 during striking the body is different from the axial direction of the sliding shaft 51, so the force sensed by the linear acceleration sensor 30 will be different, furthermore, in order to make the sensed force more accurate, the angular acceleration sensor 31 electrically connected to the MCU is arranged on the circuit board 3. While the linear acceleration sensor 30 includes three single-axis linear acceleration sensors, the angular acceleration sensor 31 includes three single-axis angular acceleration sensors, and the three single-axis linear acceleration sensors and the three single-axis angular acceleration sensors form an inertial measurement unit, so that the strength of striking and massage can be accurately sensed in different use states, thereby ensuring the safety and convenience of use.

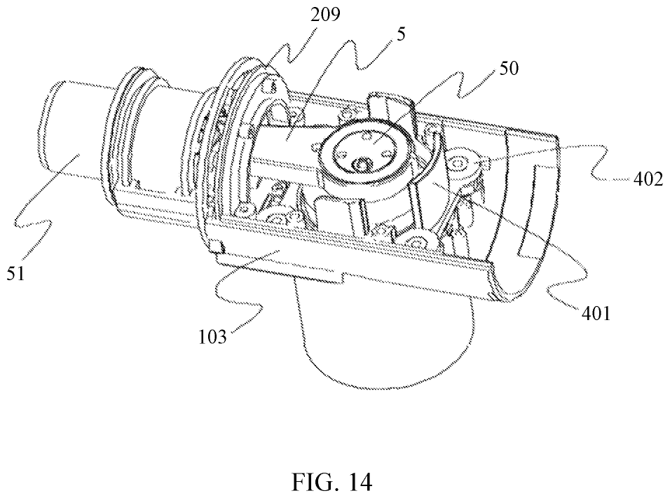

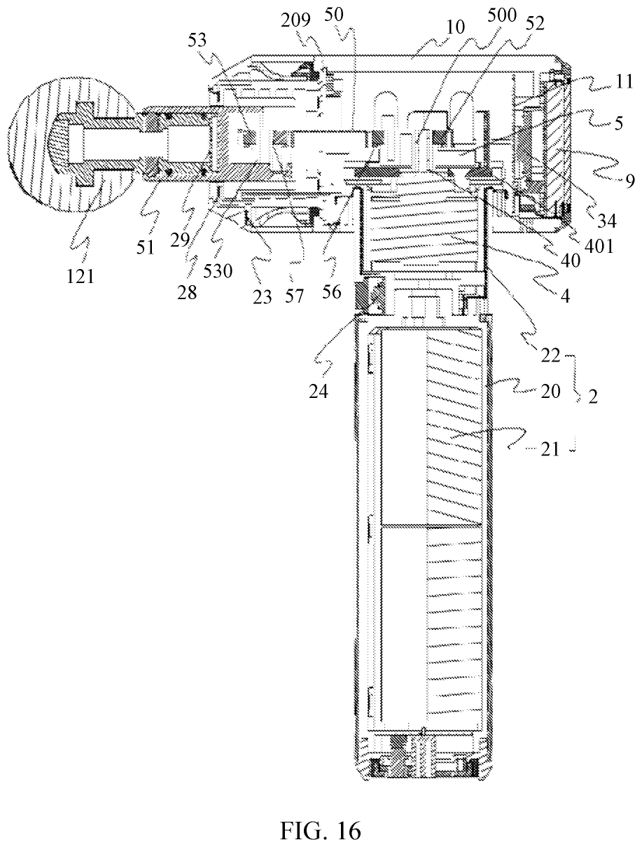

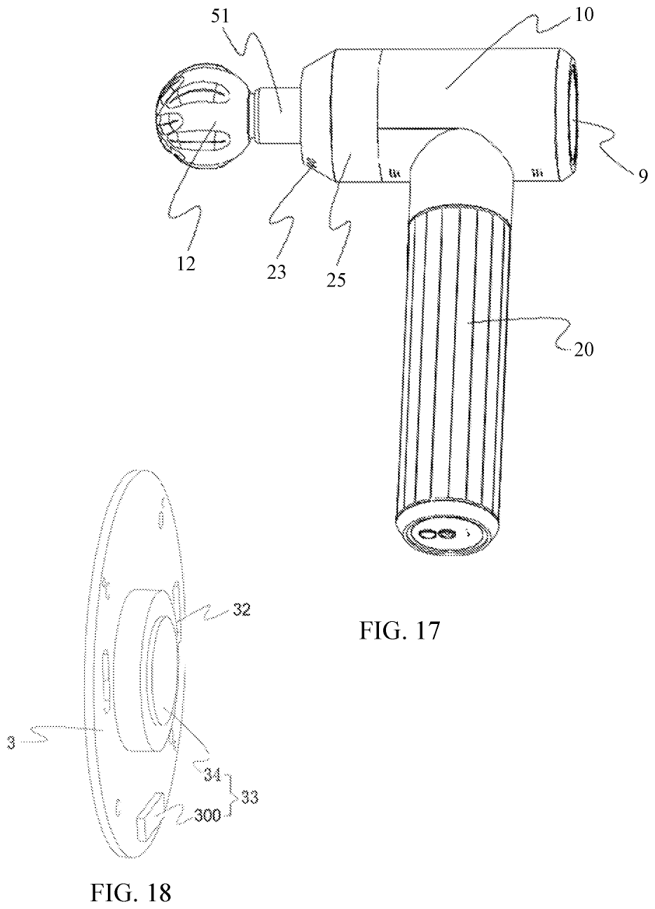

As shown in FIGS. 14-17, the reciprocating mechanism of the fascial gun in the present invention includes: the motor 4 electrically connected to the main circuit board 11 and fixed on the motor holder 401, the eccentric wheel 5 fixedly connected to the output shaft 31 of the motor 4, the connecting rod 50, and the sliding axle 51 capable of penetrating through the fascial gun housing 10 and moving forwards and backwards. The motor 4 is fixed at the bottom of the motor holder 401, its output shaft 31 penetrates through the motor holder 401 and is fixedly connected to the eccentric wheel 5, after started the motor 4, its output shaft 31 drives the eccentric wheel 5 to rotate eccentrically, meanwhile, the motor holder 401 is fixedly connected inside the fascial gun housing 10, and the rubber rings 402 are arranged at the four corners of the motor holder 401 toward the side walls of the fascial gun housing 10. In this way, the rubber rings 402 reduce the vibration transmitted by the motor 4 toward the fascial gun housing 10, and their configuration at the four corners avoids direct contact with the fascial gun housing, so as to achieve the soft contact between the reciprocating mechanism and the fascial gun housing 10 and effectively reduce the noise generated during the operation of the reciprocating mechanism. There is a first bearing 52 fixed with one end of the connecting rod 50 that is connected via transmission means to the eccentric wheel interference-fitted in the inner ring of the first bearing 52, and there is a second bearing 53 fixed with another end of the connecting rod 50 that is connected via transmission means to the sliding axle 51 fixed in the inner ring of the second bearing 53. The connecting rod 50 is an integrated transmission rod, one end of which is fixed with the first bearing 52, and the inner ring of the first bearing 52 is interference-fitted with the eccentric wheel 5, which is fixed in the inner ring of the first bearing 52 and moves synchronously with the inner ring of the first bearing 52. The connecting rod 50 is fixedly connected with the outer ring of the first bearing 52, and it moves synchronously with the outer ring of the first bearing 52, so that the relative motion between the connecting rod 50 and the eccentric wheel 5 is converted to the relative motion between the inner ring and the outer ring of the bearing. Similarly, at the another end of the connecting rod 50, the connecting rod 50 moves synchronously with the outer ring of the second bearing 53, and the sliding axle 51 moves synchronously with the inner ring of the second bearing 5, in this way, during the motor 4 driving the eccentric wheel 5 to rotate, the eccentric wheel 5 driving the connecting rod 50, and the connecting rod 50 driving the sliding shaft 51 to move back and forth, no other components are involved in the driving process, so the resultant smoother motion solves the problems of power output loss, energy consumption, and driving delay caused by the use of springs in the conventional fascial gun, and also reduces the noise generated during driving. The integrated connecting rod 50 avoids the influence of excessive connecting parts on the transmission. Both ends of the connecting rod 50 are correspondingly provided with the first through hole 54 and the second through hole 55, the lower ends of which both have annular protrusions 56 extending radially inwards, in this way, the side wall of the through hole and the upper surface of the annular protrusion 56 form a L-shaped structure. The eccentric wheel 5 extends upwards at the connection with the output shaft 31 of the motor 4 to form the connecting protrusion post 500 interference-fitted in the inner ring of the first bearing 52, the configuration of the connecting protrusion post 500 facilitates the connection and furthermore stabilizes the connection, the connecting protrusion post 500 is positioned at the rotation point of the eccentric wheel 5 and is integrated with the eccentric wheel 5, thus the connecting protrusion post 500 can be configured to fits with the blind hole or through hole to be inserted by the output shaft 31 of the motor 4. The first bearing 52 fits inside the first through hole 54 and abuts against the upper surface of the annular protrusion 56 inside the first through hole 54, thus annular protrusion 56 performs the function of supporting, and also avoids the first bearing 52 from falling off the lower part of the first through hole 54 under the action of the motor 4 during operation, and the connection is more stable. Similarly, the second bearing 53 fits inside the second through hole 55 and abuts against the upper surface of the annular protrusion 56 inside the second through hole 55, the sliding axle 51 is fixedly connected to the inner ring of the second bearing 53 by the sliding axle fixing block 530, the upper and lower surfaces of the sliding axle fixing block 530 are correspondingly provided with the connecting post 57 interference-fitted in the inner ring of the second bearing 53 and fixedly connected to the sliding axle 51, thus the connecting post 57 on the upper surface is interference-fitted in the inner ring of the second bearing 53, and the connecting post 57 on the lower surface can be connected with the sliding axle 51 by screws, providing a simple structure and a convenient connection.

In a further improvement, as shown in FIGS. 14-17, the fascial gun housing 10 includes an outer housing and an inner housing, the outer housing covers the inner housing, the inner housing includes the upper cover 102 and the bottom housing 103 engaging with each other, the reciprocating mechanism and the main circuit board 11 are arranged on the bottom housing 103, thus the inner housing is formed by the upper cover 102 and the bottom housing 103 engaging with each other, facilitating the production and assembly of the product, and coving the outer housing on the inner housing makes the upper cover 102 and the bottom housing 103 engage with each other more tightly, and the connection firmer, avoiding the problem of affecting the use caused by the unstable engagement between the upper cover 102 and the bottom housing 103 during the use of the product, or the problem of the housing cracking caused by accidental dropping. The upper cover 102 and the bottom housing 103 engage with each other to form a third through hole out of which the sliding axle 51 penetrates, semicircular openings are arranged on the upper cover 102 and the surface corresponding to the bottom housing 103, after both have engaged with each other, the two semicircular openings form the third through hole. The sliding axle 51 is detachably connected to the massage head 12, penetrating through the third through hole, the massage heads 12 are configured to be different shapes according to different body parts to be massaged and stricken, for example, a spherical head suitable to massage large muscle groups such as arms, waist, buttocks, thighs, and calves, a U-shaped head suitable to massage necks, spines and calcaneal tendons, a cylindrical head suitable to massage and impact deep tissues such as meridians, palms and soles, a flat head suitable to relax and shape various muscle parts, and an air-spring head suitable for muscle's sensitive parts or the elderly to relax muscles. A sleeve sleeving the sliding axle 51 is fixed inside the inner housing.

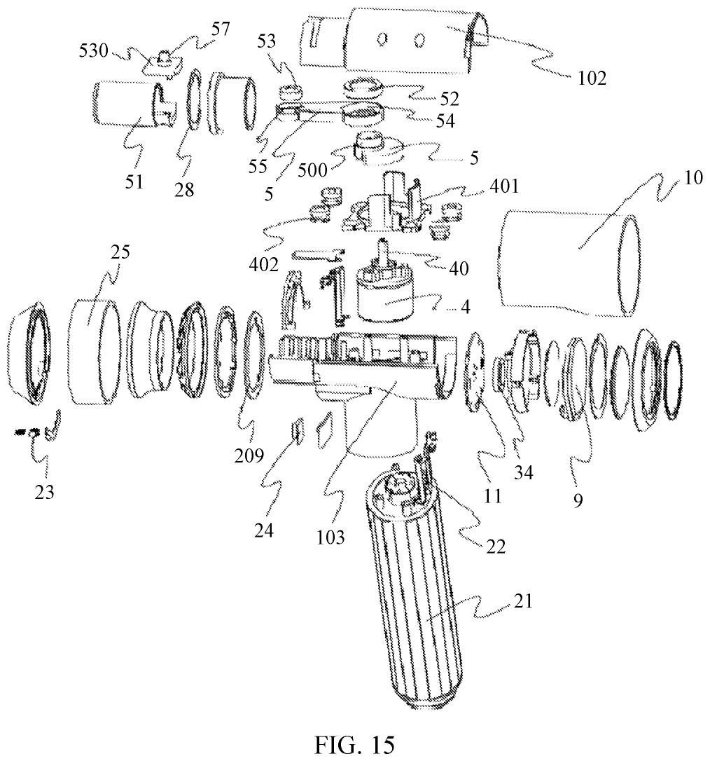

Preferably, as shown in FIGS. 15-17, the main circuit board 11 is also electrically connected with the stepless-adjustment switch 24 used for steplessly adjusting the rotation speed of the motor 4, the stepless-adjustment switch 24 is arranged on the fascial gun housing 10. For the convenience of use, the stepless-adjustment switch 24 can serve as a power supply and operation switch. In the off-state, pressing the stepless-adjustment switch 24 for a short time enables the fascial gun in an intelligent mode to automatically adjust the strength of striking; in an on-state, pressing the stepless-adjustment switch 24 for a short time enables the fascial gun in an off-state. In any state, pressing the stepless-adjustment switch 24 for a long time enables the fascial gun in a mode capable of steplessly adjusting the speed, that is, a standard mode, at this time, the motor 4 operates at a predetermined speed, and the rotation speed of the motor 4 is adjusted by manually pressing the stepless-adjustment switch 24, thus the fascial gun has different operation modes and meets various demands from people.

In a further improvement, as shown in FIGS. 15-17, the indicator lamp 209 electrically connected to the main circuit board is arranged inside the fascial gun housing 10, the light-transmitting window 25 through which the indicator light is emitted is arranged on the fascial gun housing 10. According to the indication of the indicator lamp 209, it can be intuitively known whether the gun is in an operation state, and whether there is any abnormality during operation. The light-guiding ring 26 capable of reflecting light toward the indicator lamp 209, and the light-scattering aperture 27 capable of scattering light and arranged between the light-guiding ring 26 and the indicator lamp 209 are further arranged inside fascial gun housing 10, the light-transmitting window 25 is arranged on the fascial gun housing 10 toward the position of the light-guiding ring 26. Both the light-guiding ring 26 and the light-scattering aperture 27 are annular, so that the emitted light can surround the fascial gun housing 10 in one circle, effecting a clear indication, at this time, the light-scattering aperture 27 scatters the light emitted by the indicator lamp 209, which is then reflected by the light-guiding ring 26 and transmitted from the light-transmitting window 25, embellishing the appearance of the fascial gun.

In a further improvement, as shown in FIGS. 15-17, the display screen 9 electrically connected to the main circuit board is arranged on the fascial gun housing 10. The display screen 9 displays a human body structure diagram, and shows in real time the use state of the fascial gun and the massaged body parts, such as a battery level state and types of the used massage heads. According to the different types of massage heads connected to the sliding shaft, the graphics of different massaged body parts are displayed. In the case of a “round-head” massage head, except a constant on-state for the head and the palms on the display screen, other body parts are in a flashing state, indicating that the massage head can strike and massage all body parts except the head and the palms. In the case of a “joint” massage head, the hand joints, the foot joints and the soles are in a flashing state. In the case of a “running, jumping and relaxing” massage head, the calf muscles and the soles are in a flashing state. In the case of a “limbering up and activating” massage head, the muscles of the whole body are in a flashing state.

In a further improvement, as shown in FIG. 18, the audio module 33 is provided on the main circuit board 11 of the fascial gun, an audio file is downloaded and stored in the audio module 33 in advance. When the operation of the device changes, the MCU on the main circuit board 11 transmits the relevant information to the audio module 33 according to the operation state of the device, thus the audio module 33 starts to play the corresponding audio file according to the information transmitted from the MCU on the main circuit board 11. In this way, the audio module 33 is configured to play the operation state of the fascial gun in real time. For example, in the case of using a battery, when the power is lower than a set minimum standard required for the operation of the device, the audio module 33 will automatically play a reminding sound. During operation of the device, according to the operation state of the device, the audio module 33 also play some reminding information related to its operation, such as reminding information for replacing different massage heads, adjusting the strength of striking and massage and the like, so as to enable people to know the operation information of the device by means of a played sound when it is impossible to intuitively know the operation state of the device, ensuring its normal operation and working, and avoiding the detriment caused by abnormal working and operation errors. Furthermore, the audio module 33 includes the audio chip 300 arranged on the main circuit board 11, and the loudspeaker 34 electrically connected with the main circuit board 11 and arranged inside the fascial gun housing 10, and the sound outlet opening 37 for transmitting the sound from the loudspeaker 34 is arranged on the fascial gun housing 10. An audio file is pre-stored in the audio chip 300, which may have a built-in memory module, or may be arranged on the main circuit board 11 in a manner of inserting a card. For example, the so-called OTP-type audio chip, that is, an audio chip packaged by SOP8, has several built-in commonly-used sounds that are burned thereinto by a dedicated burner, after leaving the factory, it is consolidated and cannot be modified. There is also a flash audio chip, that is, a main control chip plugged with a spiflash, wherein the main control chip is unchanged, but the flash can be repeatedly burned, requiring a spiflash burner to burn sounds, so the capacity required by the flash is also very large, and the quality of the compressed sound is very bad, such as WT588D. In addition, such as a KT404A chip supporting MP3 decoding, the flash can be directly virtualized into a U disk, in this way, it is very convenient to update the sound, people can directly copy sounds thereinto like copying a U disk, thereby choosing different audio chips according to different demands. The audio played by the audio chip 300 is emitted from the loudspeaker 34, then the sound outlet opening 17 transmits the sound of the loudspeaker 34 out of the fascial gun housing 10, and it is arranged adjacent to the loudspeaker 34, so the sound generated by the loudspeaker 34 is transmitted by means of sound wave vibrations out of the sound outlet opening 17.

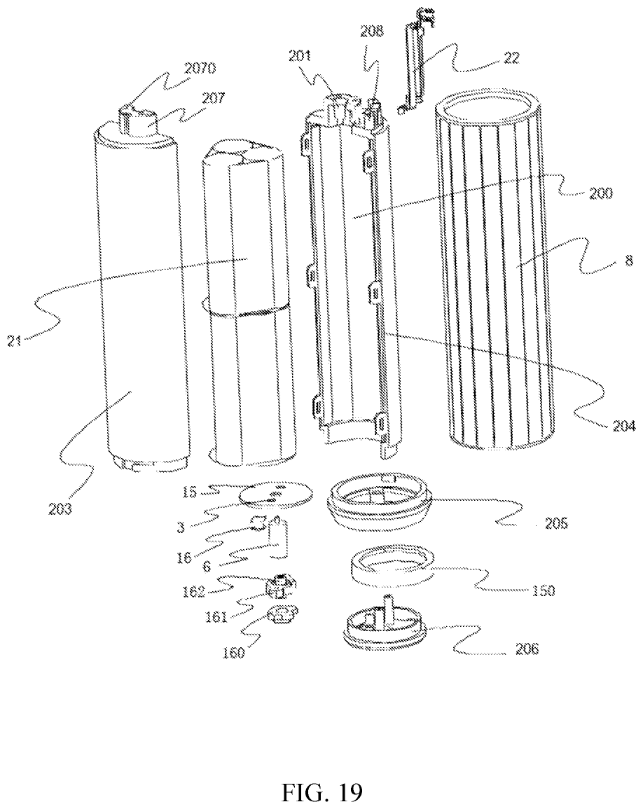

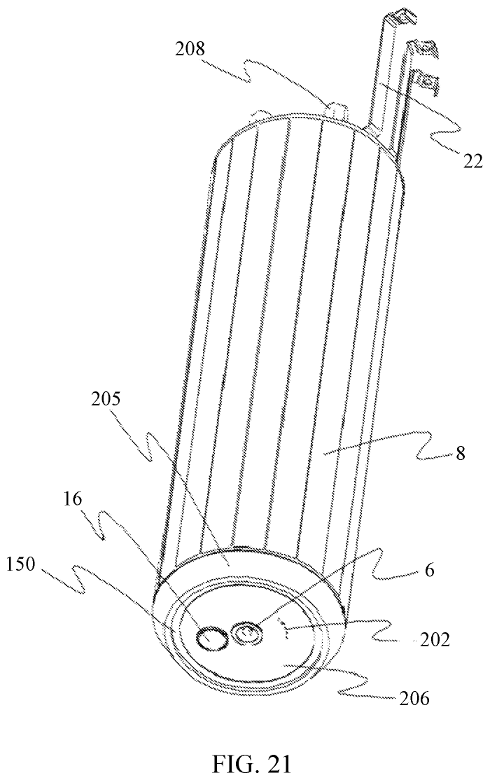

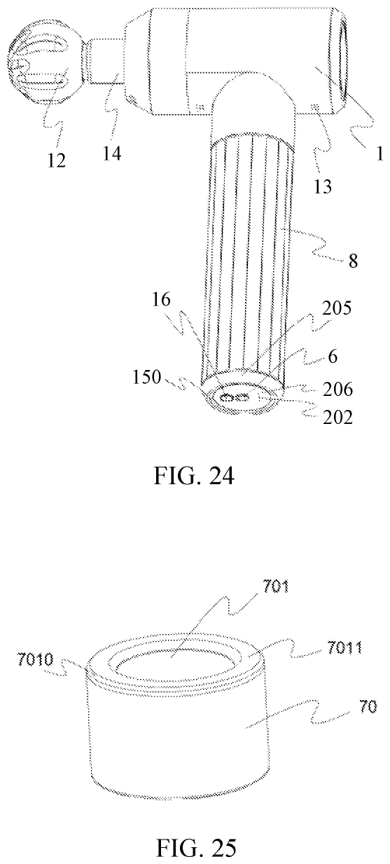

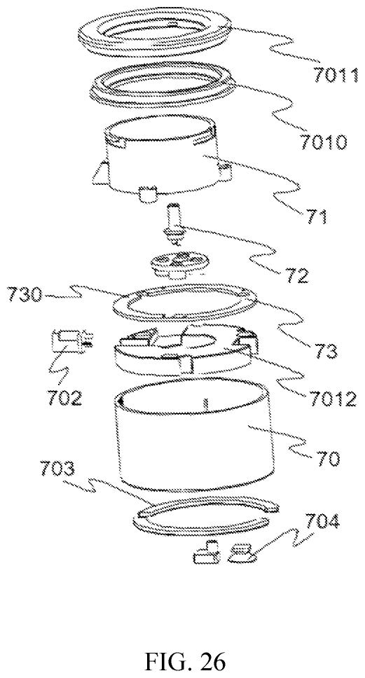

As shown in FIGS. 19-26, the electric power device of the fascial gun is an electric supply source or a battery assembly, the battery assembly 2 and the fascial gun body 1 can be connected and fixed with each other by using a screw or an engagement structure, or can be connected and fixed with each other by using a screw connection. The battery assembly 2 includes the battery housing 20 provided with the containing cavity 200 inside and connected to the fascial gun body 1 at the top, the battery pack 21 arranged in the containing cavity 200, and the power supply connection piece 22 that is arranged on the top of the battery housing 20 to electrically connect the fascial gun body 1 with the battery pack 21. In this way, the battery assembly 2 as a whole can be easily connected to the fascial gun body 1 and form electric conduction with the latter, and the battery housing 20 protects the battery pack 21 positioned inside it. The battery pack 21 supplies power to the fascial gun body 1 via the power supply connection piece 22 arranged on the battery housing 20, and the power supply connection piece 22 is fixed on the top of the battery housing 20. Meanwhile, the electrical connection between the battery pack 21 and the power supply connection piece 22 can be achieved by the wires passing through the battery housing 20 or by the power supply connection piece 22 passing through the battery housing 20, thus the battery pack 21 is integrated with the power supply connection piece 22 and the battery housing 20 as a whole that is convenient to use. The battery pack 21 is composed of a plurality of rechargeable batteries in a manner that the plurality of batteries are series-connected or parallel-connected, or first parallel-connected then series-connected, damage to a certain battery of the series connection of the plurality of batteries will affect the use of the entire battery pack. The top of the battery housing 20 is provided with the first ventilation hole 201 passing through the top of the battery housing 20, the bottom of the battery housing 20 is provided with the second ventilation hole 202 passing through the bottom of the battery housing 20. The battery pack 21 is arranged in the containing cavity 200, thus there is a space between the battery pack 21 and the battery housing 20, furthermore, after the ventilation holes are arranged on the top and bottom of the battery housing 20, a passage for airflows is formed inside the battery housing 20. After the battery assembly 2 is connected to the fascial gun body 1, in case that the ventilation holes on the top of the battery housing 20 communicate with the interior of the fascial gun body 1, during use the motor inside the fascia gun body 1 may drive the flow of airflows while rotating, so that the gas inside the fascial gun body 1 and the battery housing 20 forms a gas flow, and the gas dissipates heat during flowing so as to improve the heat dissipation efficiency; in case that the ventilation holes on the top of the battery housing 20 do not communicate with the interior of the fascial gun body 1, the heat produced by the battery will generate a temperature difference inside and outside the battery housing 20, thus the temperature difference will accelerate the heat exchange between the air inside and outside the battery housing 20 through the ventilation holes, so as to effectively dissipate the heat produced by the battery, thereby improving the heat dissipation efficiency, avoiding the battery from operating at high temperature for a long time, and prolonging the service life of the battery. Preferably, the battery pack 21 is formed by parallel-connecting a plurality of rechargeable batteries or first series-connecting and then parallel-connecting them, thus avoiding the use problem caused by the series connection of batteries, and meeting the requirement for various battery capacities. The power supply connection piece 22 includes a positive power supply connection piece, a negative power supply connection piece, and an information transmission connection piece used to transmit information for the battery pack, and the positive power supply connection piece, the negative power supply connection piece, and the information transmission connection piece are all electrically connected and conduct electricity to the fascial gun body 1 after the battery assembly 2 has been connected to the fascial gun body 1. The positive power supply connection piece and the negative power supply connection piece are connected to the positive pole and the negative pole of the battery pack 21, respectively, and the information transmission connection piece is connected to the positive power supply connection piece or the negative power supply connection piece, thus an electrical connection passage is formed after the battery assembly 2 has been connected with the fascial gun body 1, and the state information of the battery pack 21 can be transmitted to the fascial gun body 1 in time, so that once the battery is low the user can charge the battery, knowing the state of the battery in time, so as to avoid power-out during use and affecting use.

Preferably, the battery pack 21 is electrically connected with a power supply circuit board 3 arranged at the bottom end of the battery pack 21, thus the power supply circuit board 3 is used to perform control to charge and discharge the battery. The power supply circuit board 3 is provided with the first LED lamp 15 positioned downwards, thus the state information of the battery assembly 2 can be obtained intuitively by displaying the power-on or power-off and the battery level through the lamp, as shown in FIG. 19. The battery housing 20 includes the left housing 203 and the right housing 204 engaging with each other to form the containing cavity 200, the annular battery cover 205 and the battery tail cover 206, in particular the battery pack 21 is installed in the containing cavity 200, and the battery cover 205 and the battery tail cover 206 cover the bottom ends of the left housing 203 and the right housing 204, respectively, providing convenience for production and assembly, meanwhile the left housing and the right housing may be two semicircular or U-shaped housings corresponding to each other, and form the containing cavity 200 after engaging with each other. The lower end of the containing cavity has an opening which serves as the opening of the containing cavity 200, and which is concurrently formed when the left housing and the right housing engage with each other to form the containing cavity 200. The power supply circuit board 3 is positioned at the lower part of the containing cavity 200, and the lower end of the left housing 203 and the right housing 204 engaging with each other engages with the upper part inside the ring of the battery cover 205, in this way the battery cover 205 stabilizes the connection between the left housing and the right housing, so as to avoid the split caused by the loose engagement. The engagement between them can be achieved by direct engagement and fixation, or by engagement and fixation following the insertion and subsequent rotation to a certain angle, it can be configured according to different demands. The battery tail cover 206 fits inside the lower part inside the ring of the battery cover 205, and the ring-shaped first light-transmitting aperture 150 capable of transmitting the first LED light 4 is arranged between the battery tail cover 206 and the battery cover 205, in this way, the battery tail cover 206 seals the battery pack 21, the power supply circuit board 3 and the first LED lamp 15 into the containing cavity 200 formed by the left housing and the right housing, so these parts cannot be touched during use, meanwhile, the configured first light-transmitting aperture 150 is capable of transmitting light, for example, it is made from a transparent or translucent material, thus the state of the battery pack can be intuitively obtained by the light transmitted through the light-transmitting aperture. The first ventilation hole 201 is arranged on the battery tail cover 206 and allows a passage for the air flow of the containing cavity 200, it can be configured to be more than one and the number to be specified according to demands. The power supply connection piece 22 and the second ventilation hole 202 are arranged on the top surface of the left housing 203 or/and the right housing 204, that is, the second ventilation holes 202 may be arranged on the left housing 203 or the right housing 204, or on both the left housing 203 and the right housing 204, in other words, the second ventilation hole 202 penetrates through the top of the containing cavity 200. In the case that the second ventilation hole 202 is separately arranged on one housing, an extension plane extends radially inwards at the top of the housing, and a through hole arranged on the extension plane is formed. In the case that the second ventilation hole 202 is arranged on both housings, two gaps are formed at the corresponding edges on the extension planes extending radially inwards at the top of both housings, after both housings engage with each other, the two gaps are joined together to form a hole. Similarly, the power supply connection piece 22 may be arranged on the left housing 203 or the right housing 204, or on both the left housing 203 and the right housing 204. The extension portion 151 extends radially inwards along the edge of the top of the first light-transmitting aperture 150, that is, the cross section of the light-transmitting aperture is in an inverted L shape. The protrusion 2050 protrudes radially inside the ring of the battery cover 205, and a part of the top of the first light-transmitting aperture 150 abuts against the lower surface of the protrusion 2050, the lower ends of the left housing 203 and the right housing 204 abut against the upper surface of the protrusion 2050, in this way, the first light-transmitting aperture 150 is stably fixed between the battery cover 205 and the battery tail cover 206, and the top part of the first light-transmitting aperture 150 abuts against the lower surface of the protrusion 2050, so as to prevent the protrusion 2050 from sheltering the first light-transmitting aperture 150 to enable the light emitted by the first LED lamp 15 to be incapable of transmitting through the light-transmitting aperture.

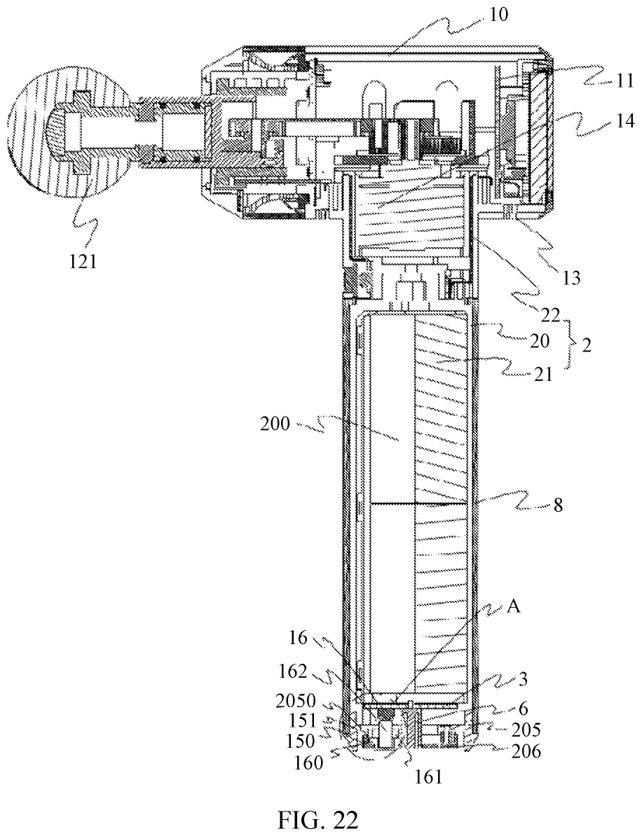

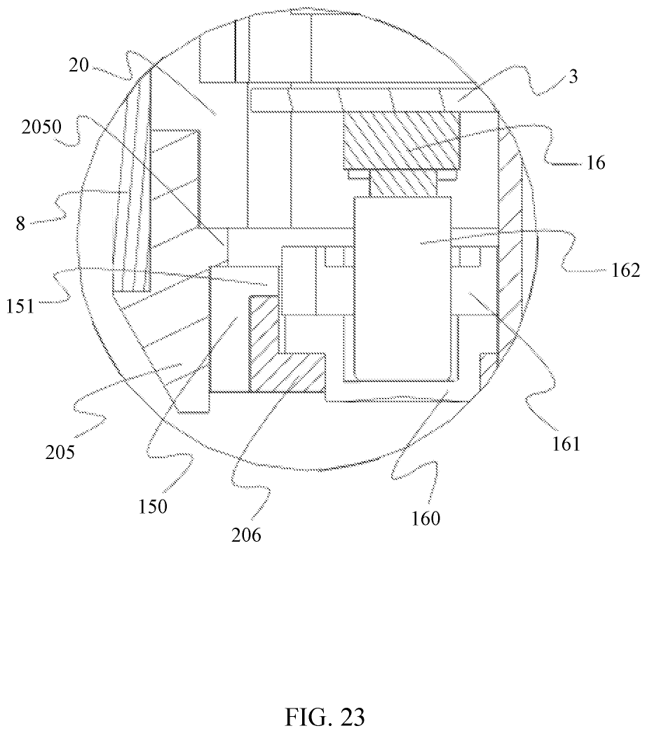

In a further improvement, as shown in FIGS. 22 and 23, the power supply circuit board 3 is provided with the power button 16 on which the silicone button cap 160 is arranged, the silicone button cap 160 is connected to the button holder 161 in which the button shaft 162 capable of sliding in the button holder 161 and positioned between the silicone button cap 160 and the power button 16 is arranged, the button shaft 162 abuts against the power button 16. It is convenient for people to perform control to charge and discharge the battery assembly 2, pressing down the silicone key cap 160 to apply a downward force on the button shaft 162, thus the button shaft 162 abutting against the power button 16 slides down under the force and depresses the power button 16 downwards thereby turning the power on or off.

In a further improvement, as shown in FIG. 19 and FIGS. 21-26, the power supply circuit board 3 is electrically connected with the first charging interface 6 used to charge the battery pack 21, the first charging interface 6 is embedded on the battery tail cover 206, the battery assembly 2 fits with the charging base 7, the charging base 7 includes the charging base outer housing 60 provided with the groove 701, and the annular charging base inner housing 71 fitting with the battery housing 20 to be inserted, the charging base inner housing 71 is arranged on the bottom surface of the groove 701 and forms an annular groove with the charging base outer housing 70, the bottom surface of the groove 701 is provided with the second charging interface 72 positioned in the charging base inner housing 71 and fitting and connected with the first charging interface 6, the charging base circuit board 73 electrically connected with the second charging interface 72 and having the second LED lamp 730 is arranged in the annular groove. When required for charging, the battery assembly 2 can be inserted into the charging base inner housing 71, and both parts fit with each other to avoid the battery assembly 2 from rocking and toppling in the charging base 7, at this time, the first charging interface 6 on the battery assembly 2 fits and is connected with the second charging interface 72 provided in the groove 701, that is, the two interfaces are a charging male fitting and a charging female fitting that fit to each other. The top matching cover of the annular groove is provided with the annular light-scattering aperture 7010 sleeved with the annular second light-transmitting aperture 7011, thus the annular light-scattering aperture 7010 and the second light-transmitting aperture 7011 serve as the cover of the annular groove to close the annular groove, and the annular light-scattering aperture 7010 uniformly scatters the light emitted by the second LED lamp 730 in the circumferential direction and transmits it through the second light-transmitting aperture 7011. The charging connector 702 electrically connected to the charging base circuit board 73 is arranged on the charging base outer housing 70, thus the charging base 7 is connected to the commercial power by means of the charging connector 702 for charging. As the battery assembly 2 and the connection of the battery assembly 2 and the fascial gun body 1 are quite heavy, in order to stabilize them during charging, the balance weight 7012 is arranged on the bottom of the charging base circuit board 73 inside the annular groove, and one of or both the anti-skid mat 703 and the sucker 704 is/are arranged on the bottom of the charging base outer housing 70, thus the balance weight 7012 is configured to stabilize the product, avoiding it from toppling, meanwhile, the anti-skid mat 703 or the sucker 704 is configured to avoid the charging base 7 from slipping, so as to stabilize the charging base 7.

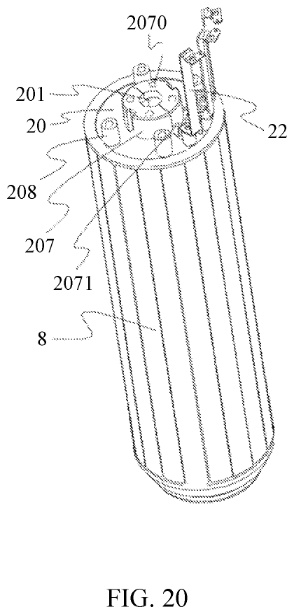

In a further improvement, as shown in FIGS. 19 and 20, the center of the top of the battery housing 20 extends axially upwards to form the power supply protruding post 207, thus the power supply protruding post 207 extends into the fascial gun body 1 and is tightly installed on it, so that there will be no looseness between both to affect use. The first ventilation hole 201 is a hole axially passing through the power supply protruding post 207, a plurality of connection holes 2070 used for connecting with the fascial gun body 1 are alternately arranged circumferentially on the edge of the top of the power supply protruding post 207, a plurality of fixation connection posts 208 used for connecting with the fascial gun body 1 are alternately arranged circumferentially on the edge of the top of the battery housing 20, thus the battery assembly 2 and the fascial gun body 1 are connected with each other at the connection hole 2070 and the fixation connection post 208 by screws, further ensuring the stability of the connection between both. The power supply hole 2071 for the connection and electric conduction between the power supply connection piece 22 and the battery pack 21 is arranged on the side wall of the supply protruding post 207. A wire can be inserted into the power supply hole 2071 to connect the power supply connection piece 22 to the battery pack 21, or the power supply connection piece 22 can extend to be inserted into the power supply hole 2071 and connected with the battery pack 21, meanwhile, the power supply hole 2071 can also be used as a ventilation hole for heat dissipation, further improving the heat dissipation efficiency.

In a further improvement, as shown in FIGS. 19-22 and FIG. 24, the battery housing 20 is covered by the silicone cover 8, thus the silicone cover 8 wraps the housing, beautifying the appearance of the product, and strengthening the handling feeling to, meanwhile stripes can be configured on the silicone cover 8 to increase the friction during handling, more easing the handling feeling.

In a further improvement, a battery monitoring module used to monitor the battery pack is arranged on the main circuit board 11, thus the battery monitoring module is configured to monitor the state of the battery pack such as battery voltage and battery level in real time after the fascial gun body 1 and the battery assembly 2 have been electrically connected with each other, when the battery level or battery voltage is low, it can remind people to charge the battery in time to ensure its normal use. The battery monitoring module is enabled based on a battery monitoring chip, such as a bq26220 chip. The third ventilation hole 13 capable of allowing a passage for the airflow of the second ventilation hole 202 is arranged on the fascial gun housing 100. The bottom of the fascial gun housing 100 is provided with an aperture gap which is connected to the second ventilation hole 202 after the battery assembly 2 has been connected to the fascial gun body 1. The third ventilation hole 13 can be arranged at any portion of the fascial gun housing 10, and may be one or more ventilation holes provided in one portion, also a plurality of ventilation holes provided at different portions, thus heat is dissipated through the first ventilation holes 201 on the battery assembly 2 and the third ventilation holes 13 on the fascial gun housing 100, thereby improving the heat dissipation efficiency.

The above descriptions are only preferred embodiments of the present invention, not intended to limit the present invention. Any modifications, equivalent replacements and improvements made within the concept of the present invention shall fall within the protection scope of the present invention.

What is claimed is:

1. A fascial gun having function of intelligently adjusting striking, comprising: a fascial gun body and an electric power device, said fascial gun body including a fascial gun housing and a massage head, said fascial gun housing being provided therein with a main circuit board with an MCU, a motor electrically connected to said main circuit board, and a reciprocating mechanism connected to an output shaft of said motor, said electric power device supplying electric power to said main circuit board, and said reciprocating mechanism being provided with a sliding shaft which penetrates through said fascial gun housing and which is connected to said massage head,
wherein said main circuit board is electrically connected with a detection device used for detecting the operating state of said fascial gun, and said MCU controls the rotation speed of said motor according to the information sent by said detection device.

2. The fascial gun according to claim 1, wherein said detection device includes a distance sensor which is arranged at the front end of said fascial gun housing and which adjoins the position out of which said sliding shaft penetrates through said fascial gun housing.

3. The fascial gun according to claim 1, wherein said detection device includes a radio frequency recognizer which is arranged on said fascial gun housing and which can identify an electronic tag arranged on said massage head, and said massage head is detachably connected to said sliding shaft.

4. The fascial gun according to claim 3, wherein said massage head includes a massage head cover and a cylindrical massage head post, said sliding shaft is a cylindrical shell which said massage head post fits inside, said massage head cover is fixedly installed on the head of the massage head post, said tail of the massage head post fits inside said sliding shaft, a positioning device is arranged between the portions where said massage head post is connected with said sliding shaft, said electronic tag is arranged inside the tail of said massage head post.

5. The fascial gun according to claim 4, wherein said positioning device includes at least one positioning bead arranged on said massage head post, and a positioning hole which is arranged on said sliding shaft and which said positioning bead fits inside.

6. The fascial gun according to claim 5, wherein said positioning bead includes a rigid spherical bead, an installation holder for installing said spherical bead, and a spring that abuts against said spherical bead and that partially exposes said spherical bead in said installation holder, an installation hole fitting with said installation holder is arranged on said massage head post.

7. The fascial gun according to claim 4, wherein said massage head post is provided with at least one engaging groove along one circumferential circle of said massage head post between the portion provided with said positioning device and the tail of said massage head post, a buffer ring fits inside and engages with said engaging groove, said buffer ring partially protrudes outside said engaging groove.

8. The fascial gun according to claim 1, wherein said detection device includes a linear acceleration sensor.

9. The fascial gun according to claim 8, wherein said detection device further includes an angular acceleration sensor.

10. The fascial gun according to claim 1, wherein said reciprocating mechanism includes: a motor electrically connected to said main circuit board and fixed on a motor holder, an eccentric wheel fixedly connected to the output shaft of said motor, a connecting rod, and a sliding axle capable of penetrating through said fascial gun housing and moving forwards and backwards; said motor holder is fixedly connected inside said fascial gun housing, rubber rings are arranged at the four corners of said motor holder toward the side walls of said fascial gun housing, there is a first bearing fixed with one end of said connecting rod that is connected via transmission means to said eccentric wheel interference-fitted in the inner ring of said first bearing, and there is a second bearing fixed with another end of said connecting rod that is connected via transmission means to said sliding axle fixed in the inner ring of said second bearing.

11. The fascial gun according to claim 10, wherein both ends of said connecting rod are correspondingly provided with a first through hole and a second through hole, the lower ends of which both have annular protrusions extending radially inwards, said eccentric wheel extends upwards at the connection with the output shaft of said motor to form a connecting protrusion post interference-fitted in the inner ring of the first bearing, said first bearing fits inside the first through hole and abuts against the upper surface of said annular protrusion inside said first through hole, said second bearing fits inside said second through hole and abuts against the upper surface of said annular protrusion inside said second through hole, said sliding axle is fixedly connected to the inner ring of said second bearing by a sliding axle fixing block, the upper and lower surfaces of said sliding axle fixing block are correspondingly provided with a connecting post interference-fitted in the inner ring of said second bearing and fixedly connected to said sliding axle.

12. The fascial gun according to claim 1, wherein said main circuit board is also electrically connected with a stepless-adjustment switch used for steplessly adjusting the rotation speed of said motor, said stepless-adjustment switch is arranged on said fascial gun housing.

13. The fascial gun according to claim 1, wherein said electric power device is an electric supply source or a battery assembly, said battery assembly includes a battery housing provided with a containing cavity inside and connected to said fascial gun body at the top, a battery pack arranged in said containing cavity, and a power supply connection piece that is arranged on the top of said battery housing to electrically connect said fascial gun body with said battery pack, said battery pack is composed of a plurality of rechargeable batteries, the top of said battery housing is provided with a first ventilation hole passing through the top of said battery housing, the bottom of said battery housing is provided with a second ventilation hole passing through the bottom of said battery housing.

14. The fascial gun according to claim 13, wherein said battery pack is electrically connected with a power supply circuit board arranged at the bottom end of said battery pack, said power supply circuit board is provided with a first LED lamp positioned downwards, said battery housing includes a left housing and a right housing engaging with each other to form said containing cavity, an annular battery cover and a battery tail cover, the lower end of said containing cavity has an opening, said power supply circuit board is positioned at the lower part of said containing cavity, the lower ends of the left housing and the right housing engaging with each other engage with the upper part inside the ring of the battery cover, said battery tail cover fits inside the lower part inside the ring of said battery cover, a ring-shaped first light-transmitting aperture capable of transmitting the first LED light is arranged between said battery tail cover and said battery cover, said first ventilation hole is arranged on said battery tail cover and allows a passage for the air flow of said containing cavity, said power supply connection piece and said second ventilation hole are arranged on the top surface of said left housing or/and said right housing.

15. The fascial gun according to claim 13, wherein the center of the top of said battery housing extends axially upwards to form a power supply protruding post, said first ventilation hole is a hole axially passing through said power supply protruding post, a plurality of connection holes used for connecting with said fascial gun body are alternately arranged circumferentially on the edge of the top of said power supply protruding post, a plurality of fixation connection posts used for connecting with said fascial gun body are alternately arranged circumferentially on the edge of the top of said battery housing, a power supply hole for the connection and electric conduction between said power supply connection piece and said battery pack is arranged on the side wall of said power supply protruding post.

16. The fascial gun according to claim 13, wherein a battery monitoring module used to monitor said battery pack is arranged on said main circuit board, a third ventilation hole capable of allowing a passage for the airflow of said second ventilation hole is arranged on said fascial gun housing.

17. The fascial gun according to claim 1, wherein an audio module is provided on said main circuit board, said audio module includes an audio chip arranged on said main circuit board, and a loudspeaker electrically connected with said main circuit board and arranged inside said fascial gun housing, a sound outlet opening used for transmitting the sound from said loudspeaker is arranged on said fascial gun housing.

18. The fascial gun according to claim 1, wherein an indicator lamp electrically connected to said main circuit board is arranged inside said fascial gun housing, a light-transmitting window through which the indicator light is emitted is arranged on said fascial gun housing.

19. The fascial gun according to claim 1, wherein a display screen electrically connected to said main circuit board is arranged on said fascial gun housing.
